(19) United States
(12) Patent Application Publication
(10) Pub. No.: US 2020/0274843 A1
(43) Pub. Date: Aug. 27, 2020

(54) CONTEXT-AWARE FEEDBACK

(71) Applicant: THOMSON LICENSING, Issy les Moulineaux (FR)

(72) Inventor: Joel M. FOGELSON, Pasadena, CA (US)

(21) Appl. No.: 16/066,134

(22) PCT Filed: Dec. 28, 2015
(86) PCT No.: PCT/US2015/067632

§ 371 Date: Jun. 26, 2018

(51) Int. Cl. H04L 12/58

(52) U.S. Cl. CPC H04L 51/32

(57) ABSTRACT

A method and apparatus that provides context-aware feedback options for a message includes: analyzing (420) content associated with the message; determining (430) a context of the message based on the content analysis; and providing (470) a set of feedback options based on the context. A method and apparatus to display feedback related to messages includes: determining (520) a context of a message; retrieving (530) information relating to the message; retrieving (540) a set of feedback elements associated with the message; and modifying (570) at least one feedback element based on the retrieved information.

### FIELD

The disclosure generally relates to feedback regarding social messaging.

### BACKGROUND

Social networking is ubiquitous in society. Many social networking resources allow users to post comments and/or other feedback about a particular message (e.g., a photograph, a news article, a product, a service, etc.). Current social networking sites may allow a user to select from various feedback options (e.g., users may be able to “like” a message, give the message a “thumbs up”, etc.).

Existing solutions merely present a fixed set of options without regard for the context of the post. Viewers may wish to provide feedback but may not feel that the standard options are appropriate.

In addition, a particular user may wish to control how feedback provided by that user is shared with others.

Thus there is a need for a system that generates context-aware feedback options and allows users to control how feedback is shared.

### SUMMARY

Some embodiments provide feedback options for online content based on the context of the content. Such content may include, for instance, social media messages, product reviews, etc. The feedback options may include a set of selectable elements. Such selectable elements may include text-based feedback options, graphical options (e.g., emoticons, clip art, etc.), and/or other appropriate selectable elements (e.g., audio feedback, videos, etc.).

The context of an message may be determined through image analysis, metadata mining, text mining, word analysis, text analytics, etc. Such context may relate to broad categories, such as positive, negative, or neutral subject matter. Context may also relate to more particular subject matter, such as sub-categories of good news (e.g., birthday, anniversary, etc.), categories of users (e.g., based on region, affiliation to university, etc.), content types or genres (e.g., music, action films, etc.), and/or other relevant categories.

The set of feedback options may be identified or generated based on the determined context. For instance, messages related to good news may have one set of options while messages related to bad news may have a different set of options. A user may be able to select from among the feedback options, where such selections may cause the message to be updated to include the selected feedback.

Some embodiments may present feedback in various different ways and/or otherwise modify the feedback based on various relevant factors. For instance, some embodiments may determine a context, determine various viewer attributes (e.g., age, group membership, etc.), and/or other relevant factors in order to provide appropriate feedback when viewed by various parties.

For instance, some groups (e.g., family, friends, coworkers, acquaintances, etc.) may receive and/or be able to view different feedback than others. For example, sarcastic feedback may be seen by “friends” on a message, but “coworkers” viewing the message may see a modified message without the sarcasm (or no message at all). Feedback to messages may also be modified based on the subject matter of the message (e.g., feedback concerning adult topics may be withheld from specified groups of users).

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a context-aware feedback system according to an exemplary embodiment;

FIG. 2 illustrates an example graphical user interface (GUI) of some embodiments;

FIG. 3 illustrates a flow chart of an exemplary client-side process that analyzes messages and provides context-aware feedback options;

FIG. 4 illustrates a flow chart of an exemplary server-side process that analyzes messages and provides context-aware feedback options;

FIG. 5 illustrates a flow chart of an exemplary server-side process that analyzes messages and modifies displayed feedback based on user preferences; and

FIG. 6 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally allow context-aware feedback for online content. Such content may include, for instance, social media messages, product reviews, etc. Throughout this disclosure, the terms “posting” or “post” may be used to refer to online content items that may include or allow feedback. In another definition, a posting may be a “message” in which another user can give some type of feedback (e.g., using a “like” button, a rating, etc.) for the message. More particularly, a social media posting can be a posting or message that is associated with a social media service like FACEBOOK, INSTRAGRAM, and the like

The context of an message may be determined through image analysis, metadata mining, text mining, word analysis, text analytics, etc. The set of feedback options may be generated and/or modified based on the determined context.

A user may be able to select from among the feedback options (e.g., a list of messages) when viewing the message. Throughout this disclosure, the term “user” may be used to refer to content generators (or “posters”), content viewers, content providers, and/or other appropriate entities that may interact with content that includes or allows feedback. In some embodiments, presentation of feedback (in the form of presented options and/or display of previously received feedback) may be modified based on various relevant factors (e.g., user preferences, user demographic information, etc.).

A first exemplary embodiment provides a method that provides context-aware feedback options for an message. The method includes: analyzing content associated with the message, determining a context associated with the message based on the content analysis, and providing a set of context-specific feedback options based on the context.

A second exemplary embodiment provides a server that provides context-aware feedback to an message. The server includes: a processor for executing sets of instructions, and a non-transitory medium that stores the sets of instructions. The sets of instructions include: analyzing content associated with the message, determining a context associated with the message based on the content analysis, and providing a set of context-specific feedback options based on the context.

A third exemplary embodiment provides a method for displaying feedback related to messages. The method includes: determining a context of a message, retrieving information relating to the message, retrieving a set of feedback elements associated with the message, and modifying at least one feedback element based on the retrieved information.

A fourth exemplary embodiment provides a server that displays feedback related to messages. The server includes: a processor for executing sets of instructions, and a non-transitory medium that stores the sets of instructions. The sets of instructions include: determining a context of a message, retrieving information relating to the message, retrieving a set of feedback elements associated with the message, and modifying at least one feedback element based on the retrieved information.

Several more detailed embodiments are described in the sections below. Section I provides a description of an exemplary system architecture. Section II then describes an example graphical user interface of some embodiments. Next, Section III describes exemplary methods of operation. Lastly, Section IV describes an exemplary computer system.

### I. System Architecture

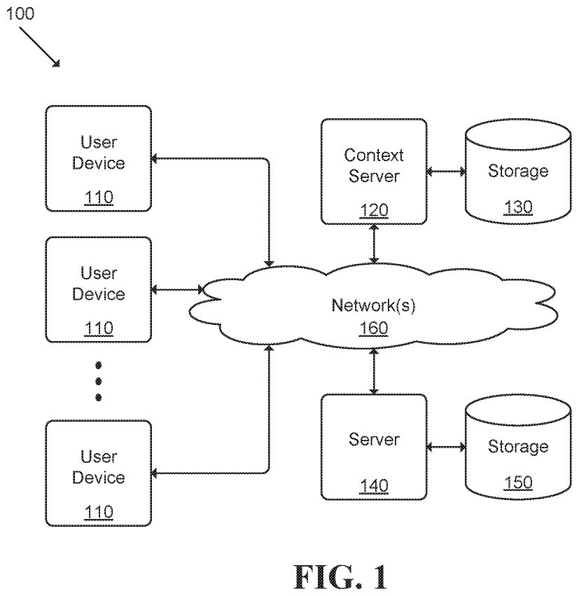

FIG. 1 illustrates a schematic block diagram of a context-aware feedback system 100 according to an exemplary embodiment. As shown, the system may include a set of user devices 110, a context server 120 with associated storage 130, a server 140 and associated storage 150, and network(s) 160.

Each user device 110 may be an electronic device capable of interacting with a social network. Such devices may include, for instance, personal computers, tablets, smartphones, laptops, televisions, gaming consoles, etc. User device 110 may include various user interface elements (e.g., a touchscreen, keyboard or keypad, microphone, speaker, etc.). In addition, the device may include various processing elements, storages, interfaces, etc. In some embodiments, the device may be able to execute various applications that may be able to interact with other elements of system 100.

The context server 120 may be a computing device that is able to determine the context of an message (or “post”) Such a message may include a social media message, an online review, a product message, a service message, etc. The term “message” may also be used to refer to messages, comments, and/or responses relating to such online content. The context server may determine the context of such a message through image analysis, metadata mining, text mining, word analysis, text analytics, etc. The context server may be able to determine the type of media of a message (e.g., picture, text, sound, video, etc.), and whether a message relates to positive, negative, or neutral topics and/or subject matter.

Furthermore, it may be determined whether a message relates to various particular activities, topics, and/or subject matter (e.g., photographs, personal comments, personal achievements, family, sporting events, music, art, employment, school, good news, bad news, tragedies, etc.). The context server may generate feedback options to a user message feedback on social media (and/or other appropriate resources). Such feedback options may include standard options and context-specific options. The context server may also generate feedback options based on the context of one or more messages, comments, and/or other feedback about a message. In some embodiments, the context server functionality may be provided by the server 140.

Each storage 130 may be a device capable of storing information associated with the context of social media messages (and/or other online content). The storage may be accessible across various networks or communication pathways. In some embodiments, the storage may be accessed via an application programming interface (API) and/or other appropriate resources.

The server 140 may be a computing device able to execute instructions and/or process data. The server may provide social networking features. The server may be able to retrieve information from storage 150. The server 140 may provide any social resource that may allow individuals to rate, critique, comment on and/or provide other feedback to online content such as a post, product, service, etc. Such social resources may include social networking sites, review sites, classified advertising sites, etc. The server may also allow individuals to “tag” (i.e., associate others with and/or notify others about online content) other individuals or groups to a particular post, product, service, and/or other online content. In some embodiments, the functionality of the server and the context server 120 may be provided by a single server device (or set of devices).

Each storage 150 may be a device capable of storing social media content (and/or other online content). In some embodiments, storage 130 and storage 150 may be provided by a single set of devices (where the single storage may include multiple devices distributed across multiple locations).

Network(s) 160 may allow user device 110 to communicate with context server 120, storage 130, server 140, storage 150, and/or other appropriate network-accessible resources. In this way, mobile device 110 may be able to send commands or other information to context server 120 and server 140. Likewise, context server 120 and server 140 may be able to send commands or information to mobile device 110. Such networks 160 may include wired networks (e.g., Ethernet, fiber-optic, etc.), wireless networks or communication channels (e.g., Wi-Fi, Bluetooth, etc.), cellular networks, etc.

As one example operating scenario, a user device 110 may access a social media post (and/or other online content) from server 140 via network(s) 160. Context server 120 may analyze the context of the post and generate, based on the context, feedback options that may include standard feedback and context-specific feedback. The feedback options may be identified or generated based on context profiles or other appropriate resources available at storage 130. The feedback options may be sent to a user device 110 via network(s) 160. A user may select one or more of the feedback options via user device 110, which may be used to update the message on social media via server 140 and network(s) 160. The updated message may be stored at storage 150.

In some embodiments, the server 140 may request the feedback options from the context server 120 (e.g., by sending a message including at least a portion of the content). Some embodiments may identify the feedback options at the server 140 without any interaction with a separate context server 120.

System 100 may thus be able to provide users with appropriate feedback options for message to social media. Context server 120 may analyze social media and provide users with a variety of responses based on the context. This improves upon current solutions, which do not allow context-specific feedback. For example, in the case of a message about a death or a divorce, it may be inappropriate to “like” the message, and there may be no options other than to “like” or ignore the message. System 100 may allow users to respond appropriately to such a message with a response such as “My condolences” or “I'm sorry”. Some embodiments may remove feedback options for messages that meet certain criteria. For example, while some social networking sites allow feedback options such as “like” and “dislike”, for messages found to represent a tragic event (e.g., a funeral, a natural disaster, a terrorist attack, etc.), the “like” and/or “dislike” option may be unavailable, and/or appropriate context-specific feedback may be available.

One of ordinary skill in the art will recognize that system 100 is exemplary in nature and may be implemented in various specific ways without departing from the scope of the disclosure. For instance, although the system has been described as having particular components and communication pathways, different systems may include various other components (and/or remove various components) and/or include various other communication pathways (e.g., a communication bus accessible to each of the various components).

### II. Graphical User Interface

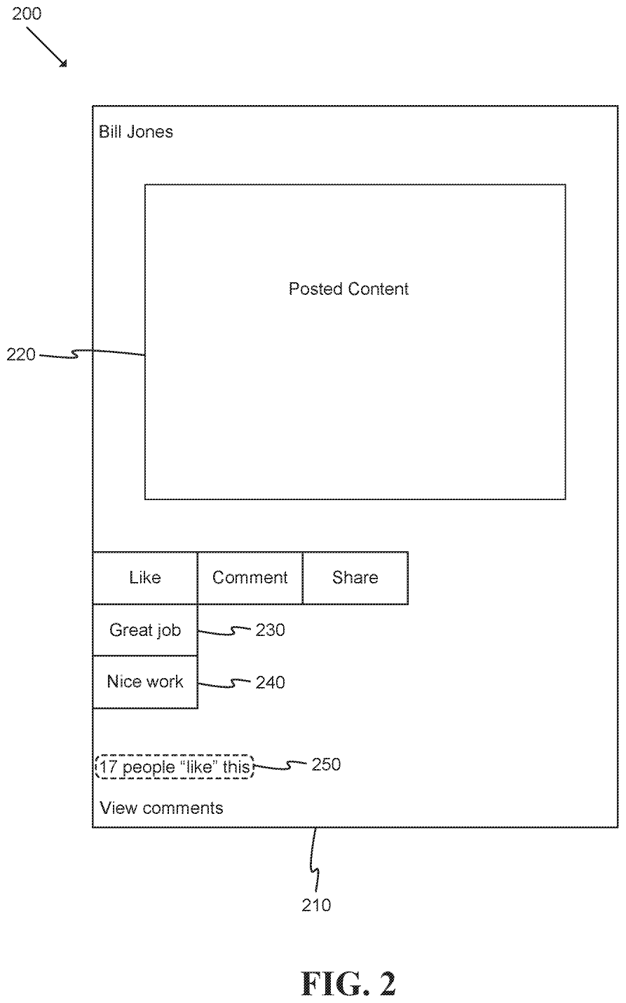

FIG. 2 illustrates an example GUI 200 of some embodiments. As shown, GUI 200 includes an example message 210, which may include various elements including posted content 220, a first context-specific feedback option 230, a second context-specific feedback option 240, and a feedback indicator 250.

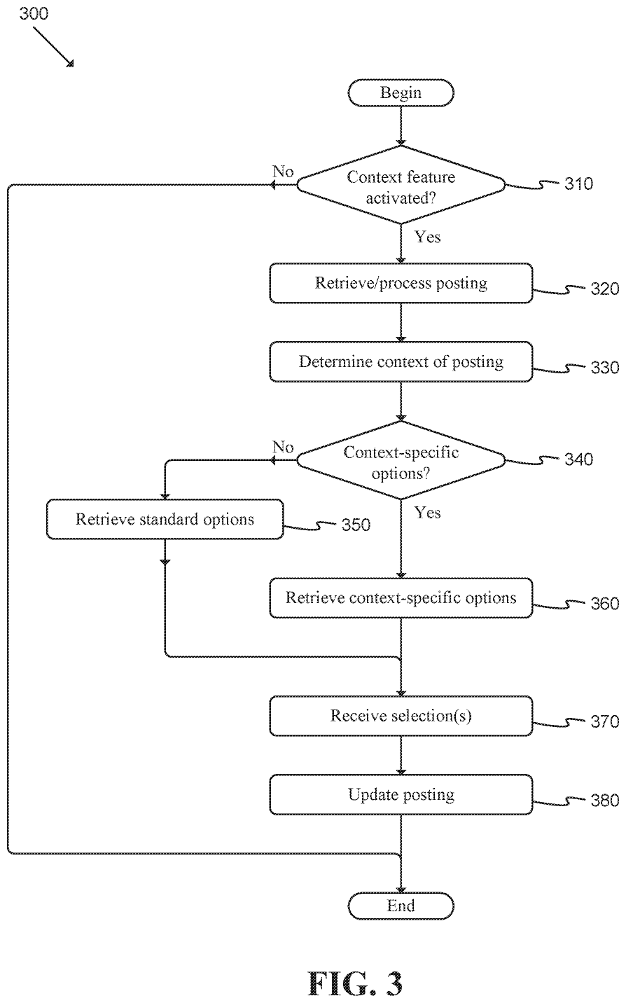

The posted content 220 may include any content posted online such as photographs, text, and/or content relating to personal achievements, family, sporting events, music, art, employment, school, good news, bad news, tragedies, etc. The GUI 200 may allow users to drag-and-drop files onto the content area 220, type text into the area, and/or otherwise associate content with a post. The optional feedback may be generated using various processes such as those described below in reference to FIGS. 3-5.

The context-specific options 230-240 may include various context-specific options presented in relation to the comment being given. Such options may be identified or modified based on various relevant factors such as context of the comment, type of media (e.g., picture, sound, video, etc.), etc.

The feedback indicator 250 may tally the number of users that have selected from among the various feedback options. Some embodiments may show individual tallies for each option (e.g., “17 people ‘like’ this”, “5 people said ‘great job’”, etc.) that may be displayed as a list, menu, and/or other appropriate element. Some embodiments may aggregate the tallies in various appropriate ways (e.g., “22 people responded”, “15 people offered support”, etc.)

One of ordinary skill in the art will recognize that GUI 200 is exemplary in nature and may be implemented in various specific ways without departing from the scope of the disclosure. For instance, although GUI 200 includes various “buttons” that may be used to select feedback options, some embodiments may include other selectable elements such as drop-down or pop-up menus, radio lists, emoticons or other selectable icons (e.g., a smiley face may be an option for content that is determined to be good news, while a frown face may be an option for content that is determined to be bad news), etc.

### III. Methods of Operation

FIG. 3 illustrates a flow chart of an exemplary client-side process 300 that analyzes messages and provides context-aware feedback options. Such feedback may be provided as described in system 100 above. Process 300 may be executed by a user device such as user device 110. Process 300 may begin, for instance, when a user accesses social media via a user device.

As shown, the process may determine (at 310) whether a context feature has been activated. Such a determination may be made in various appropriate ways. For instance, process 300 may determine whether a flag or other indicator has been set by a user or application. The indicator may be set based on user selections, application settings, and/or other relevant factors (e.g., whether a social media application is currently running).

If the process determines (at 310) that the context feature has not been activated, the process may end. If the process determines (at 310) that the context feature has been activated, the process may then retrieve and/or process (at 320) a message. Such a message may be retrieved from an appropriate resource (e.g., server 140) or otherwise supplied to process 300 (e.g., as part of a display operation associated with a social media site, as embedded data within a feed, etc.). The message may be a social media message and/or other message. In some embodiments, the process may generate a new message (e.g., via a social media interface where individuals post online content and choose feedback options).

Next, the process may determine (at 330) the context of the message. Such a determination may be made in various appropriate ways (e.g., based on analysis by the context server 120 and information from storage 130, described above in reference to FIG. 1). The process may determine (at 330) whether the message relates to positive, negative, or neutral subject matter.

More specifically, the process may determine whether the message relates to various particular activities, topics, and/or subject matter (e.g., photographs, personal comments, personal achievements, family, sporting events, music, art, employment, school, current events, good news, bad news, tragedies, etc.).

The context of a post may be determined with information from profiles (i.e., sets of criteria that can match to and/or have a threshold matching level with various elements in an message). For example, one profile may identify text associated with good news (e.g., “birthday”, “anniversary”, etc.) and provide a list of associated feedback options (and/or list of options to omit or modify), while another profile may identify text associated with bad news (e.g., “obituary”, “unhappy”, etc.) and provide a different list of options and/or modifications. As another example, a profile could include the name of a sports team and then include feedback options related to the sport and/or team (e.g., “Go Badgers!”).

Profiles may be matched to content in various appropriate ways. For instance, some profiles may list a group of content elements (e.g., a list of words, image data, user information, audience information, etc.). In some cases, a match may include any direct match of one element from the message to one element from the profile. In other cases, a matching threshold may be specified (e.g., at least four items match out of ten specified in the profile, at least fifty percent of user demographic information must match the profile, etc.). Multiple profiles may be applied to a single message (e.g., a message may be identified as “good news”, and then further identified as related to a sub-category of good news such as a graduation). Profiles may be matched to online content (e.g., a social networking message) and to the content of comments relating to such online content.

The process may then determine (at 340) whether context-specific options are available for the retrieved message. This may be determined based on the context and/or subject matter of the message, and information about the user, groups associated with the user, sharing level (e.g., “public” or “private”), etc. If the process determines (at 340) that no context-specific options are available, the process may retrieve (at 350) standard options. Standard responses may include generic responses (e.g., a “thumbs up”, a “thumbs down”, a “like”, etc.).

If the process determines (at 340) that context-specific options are available, the process may retrieve (at 360) context-specific responses and add them to a list of standard responses. Context-specific options may be based on the context of a message, user information, group information, sharing level, etc. For example, if a message relates to a sports victory, various context-specific responses may include “Congratulations on the win!”, “Good work”, etc. Alternatively, if a message relates to a sports loss, context-specific responses may include “Better luck next time”, “Nice try”, an emoticon, etc.

In some embodiments, the context-specific options may include modification to standard or content-specific options. For instance, if the context indicates bad news, a “like” button may be removed. As another example, if the context indicates good news, a “dislike” button may be removed.

Next, the process may receive (at 370) one or more feedback selections. Such selections may include standard responses and/or context-specific responses. For example, a user may select, via a device such as user device 110, one or more responses from the standard options and/or context-specific options based on the context of a particular message. Such selection(s) may be saved to a storage such as storage 150 and/or may be made available to a server or other resource such as server 140. The process may then update (at 380) the message or posting based on the received selection and then may end.

While process 300 has been described as including a user device that is able to access social media, send requests, and/or receive responses, some embodiments may provide a process with a server that may perform such operations (i.e., send a request, receive a response, perform a task based on the response, etc.).

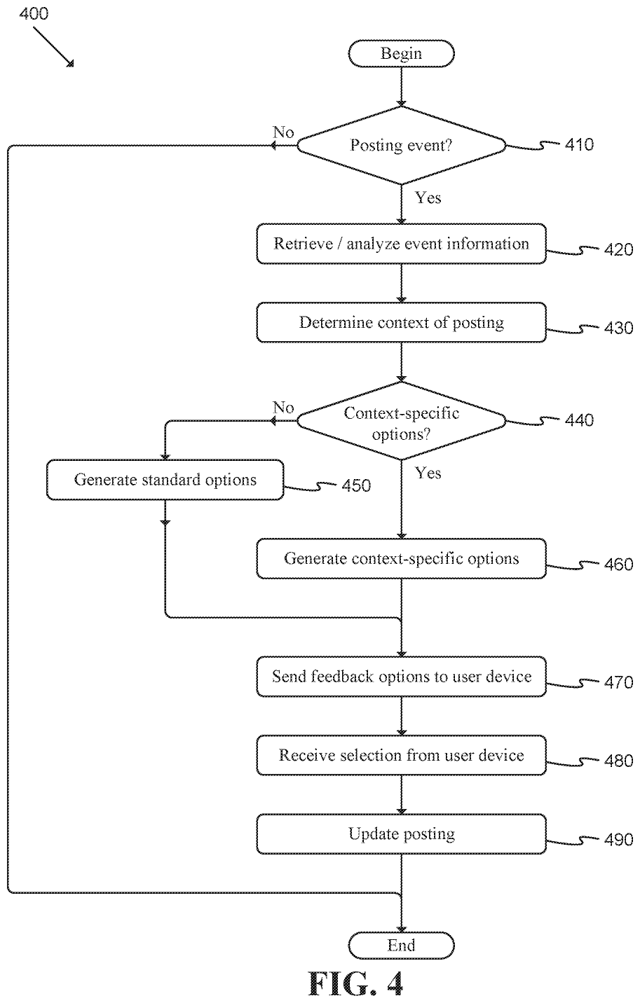

FIG. 4 illustrates a flow chart of an exemplary server-side process 400 that analyzes messages and provides context-aware feedback options. Such a process may be executed by an element such as context server 120 and/or server 140. Process 400 may serve as a complement to process 300. Process 400 may begin, for instance, when a social media (or other online) message is made available for viewing.

As shown, the process may determine (at 410) whether a message event has occurred. Such a determination may be made in various appropriate ways. For instance, process 400 may determine, through a server such as server 140, whether a message event has occurred. If the process determines (at 410) that a message event has not occurred the process may end. If the process determines (at 410) that a message event has occurred, the process may then retrieve (at 420) and analyze event information (e.g., user information, message content, provider information, etc.). User information related to the event may include biographical data, employment information, user preferences, user settings, user interests, etc. User information may also include information about family members, friends, coworkers, acquaintances, etc. Provider information may include biographical data, employment information, provider interests, etc. Event information may be analyzed to determine appropriate responses to a message for a particular user.

The process may then determine (at 430) the context of a message. Such a determination may be made in various appropriate ways (e.g., based on analysis by the context server 120 and information from storage 130, described above in reference to FIG. 1). The process may determine (at 430) whether the message relates to positive, negative, or neutral subject matter. More specifically, the process may determine whether the message relates to various particular activities, topics, and/or subject matter (e.g., photographs, personal comments, personal achievements, family, sporting events, music, art, employment, school, current events, good news, bad news, tragedies, etc.). In order to determine appropriate responses to messages for a particular user (as described below) the process may also determine the context of user information, information relating to groups associated with the user, sharing level information (e.g., “public” or “private”), etc.

The context of a post may be determined with information from profiles (i.e., sets of criteria that can match to and/or have a threshold matching level with various elements in an message). For example, one profile may identify users meeting certain criteria (e.g., user age within range of twenty-five to forty years old, user from Massachusetts, user attending Harvard, etc.) and provide message options (and/or list of options to omit or modify) for different users (e.g., a feedback reply may only be viewed by users under thirty years old, by friends, etc.). As another example, a profile may identify slang, jargon and/or colloquial text and provide a translation for certain users (e.g., surfer slang feedback “radical” could be translated to “good for you” for coworkers). Profiles are further described above in reference to FIG. 3.

Next, the process may determine (at 440) whether context-specific options are available for the message. This may be determined based on the context and/or subject matter of the message. If the process determines (at 440) that no context-specific options are available, the process may generate (at 450) standard options. Standard responses may include generic positive and negative responses, a “thumbs up”, a “thumbs down”, a “like”, a “dislike”, etc. Standard options may include commonly used words and phrases (e.g., “Looking good”, “Congratulations”, “That's too bad”, “I'm sorry to hear that”, “Good work”, “I wish I was there”, “LOL”, etc.). Standard options may also include emoticons.

If the process determines (at 440) that context-specific options are available, the process may generate (at 460) context-specific responses. Such responses may be generated by a server such as context server 120, and may be based on information from a storage such as storage 130. Context-specific options may be based on the context of a message. For example, if a message relates to a wedding, various context-specific responses may include “Congratulations!”, “Enjoy the honeymoon”, etc. Alternatively, if a message relates to a funeral, context-specific responses may include “I'm sorry for your loss”, “My heart is with you”, etc. In some embodiments, context-specific options may also include a list of standard options.

In some embodiments, generation of context-specific options may include modification of available options depending on the context or other relevant factors (e.g., user settings, group settings, etc.). Such modifications may include, for instance, removal of options based on context, translation of options into other idioms based on user or group settings, filtering of options based on user or group settings, etc.

Next, the process may send (at 470) feedback options to a user device (e.g., user device 110). The user device may display the feedback options for a particular message for a user to choose from. The process may then receive (at 480) a selection from the user device. Finally, the process may update (at 490) the message based on the received selection and then may end.

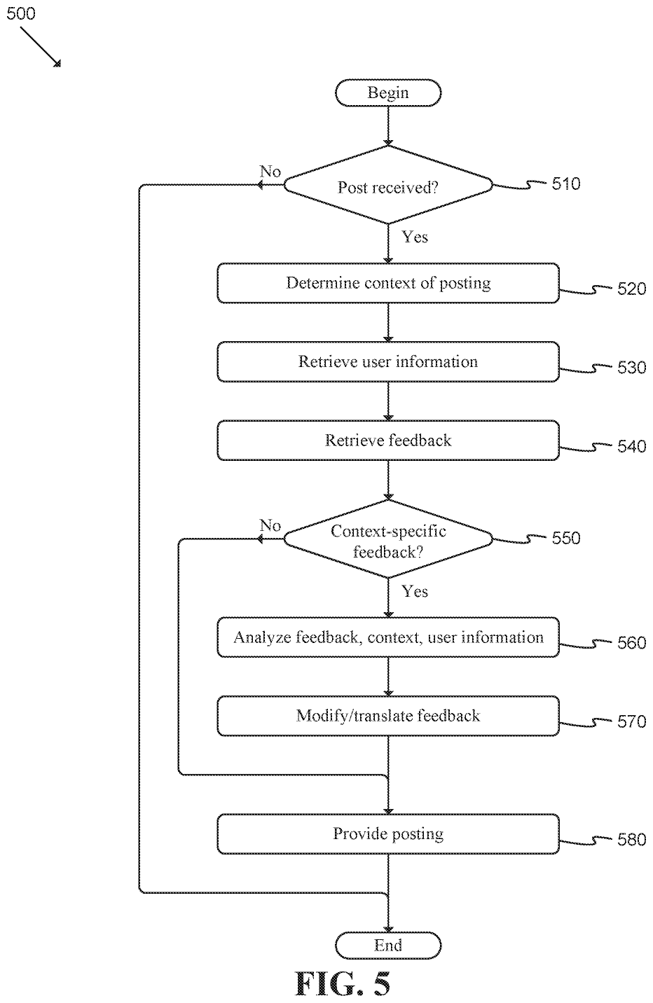

FIG. 5 illustrates a flow chart of an exemplary server-side process 500 that analyzes messages and modifies displayed feedback based on user preferences. Such a process may be executed by an element such as context server 120 and/or server 140. Process 500 may begin, for instance, when a social media (or other online) message is made available for viewing.

As shown, the process may determine (at 510) whether a message has been received. Such a determination may be made in various appropriate ways. For instance, process 500 may determine, through a server such as server 140, whether a post has been received by a device such as user device 110. In some embodiments, the message may be received as part of a social media feed or other similar resource. A user may access a social media site or resource, and various messages may be provided. In some embodiments, the message may be received via a distribution path that includes the user (e.g., a user of a chat group may receive messages as they are posted by other users). Various web interfaces, applications, and/or other appropriate resources may be utilized to distribute such messages. If the process determines (at 510) that a post has not been received the process may end.

If the process determines (at 510) that a post has been accessed, the process may then determine (at 520) the context of the post. Such a determination may be made in various appropriate ways (e.g., based on analysis by the context server 120 and information from storage 130, described above in reference to FIG. 1). In some embodiments, the determined context information may be embedded into the post itself for future use.

Process 500 may then retrieve (at 530) and analyze user information. Such user information may include biographical data, user preferences and/or settings, user interests (e.g., favorite activities, sports teams, books, movies, etc.), user experiences (e.g., employment, school, travel, etc.), groups a user is associated with, etc. User information may also include such information about family members, friends, coworkers, acquaintances, etc. The process may also retrieve (at 530) information about the provider of the message. Such provider information may include biographical data, employment information, provider preferences, provider interests, groups a provider is associated with, etc. User and provider information may be analyzed to determine appropriate responses to a particular post for a particular user.

Next, the process may retrieve (at 540) feedback relating to the accessed post. The feedback may include standard feedback and/or context-specific feedback. The process may then determine (at 550) whether context-specific feedback has been retrieved. If the process determines (at 550) that no context-specific feedback has been received, the process may provide (at 580) the message with retrieved standard feedback and then may end.

If the process determines (at 550) that context-specific feedback has been retrieved, the process may then analyze (at 560) the retrieved feedback, the context of the message, user information, and/or any other appropriate information. The context of the message may be analyzed and determined as described above in sub-process 430 in reference to FIG. 4. User information may include user preferences and/or settings, through which users may sort people into different categories and/or groups (e.g., family, friends, coworkers, acquaintances, neighbors, ex-girlfriends/boyfriends, clients, fellow church members, fellow team members, etc.). User preferences may control various threshold levels and/or filters relating to the content of context-specific feedback sent to different groups. For example, user preferences might allow a profane and/or vulgar message to be sent to and/or viewed by “friends”, but not “family” or “coworkers”. Group filters may also determine who is able to view various subject matter and/or content (e.g., feedback related to “partying” may only be viewed by selected groups). Furthermore, user preferences may control who may view feedback based on the source of the message (e.g., an ex-boyfriend may not be able to view a message on a post of a current boyfriend).

Next, the process may modify (at 570) and translate the retrieved feedback. This may be based on the analysis (at 560) of the retrieved feedback, the context of the message, and/or user information. Based on user preferences, the context of a message, and/or other relevant information, the process may modify (at 570) and/or translate retrieved feedback. For example, a message may include feedback options (and/or other associated information such as tallies) for friends (e.g., “radical”), while the feedback options may be different for co-workers (e.g., “like” or “that's great”) or removed completely. In some embodiments, the process may translate retrieved feedback into different languages or idioms.

The feedback may be modified in based on various appropriate criteria (e.g., user preferences, group membership, user demographics, etc.). Such criteria may include profiles based on previous feedback selections or other relevant factors related to users (e.g., demographic information, cultural information, etc.).

The process may then provide (at 580) and/or update the message with retrieved and/or modified feedback and then may end. Such provision may include display of the message, storing the modified content, and/or other appropriate ways of delivering the content or otherwise making the content available (e.g., via an API).

Although the above example has been described by reference to feedback selections, similar processes may be used to translate, withhold, and/or otherwise modify feedback and/or other content associated with a message (e.g., comments, biographical information, etc.).

One of ordinary skill in the art will recognize that processes 300-500 are exemplary in nature and may be implemented in various different ways without departing from the scope of the disclosure. For instance, the operations may be performed in different orders, different operations may be included, and/or some operations may be omitted. In addition, the processes (and/or portions thereof) may be performed iteratively, at regular intervals, and/or based on some specified criteria. Furthermore, each process may be performed as a part of a macro-process and/or be divided into multiple sub-processes.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

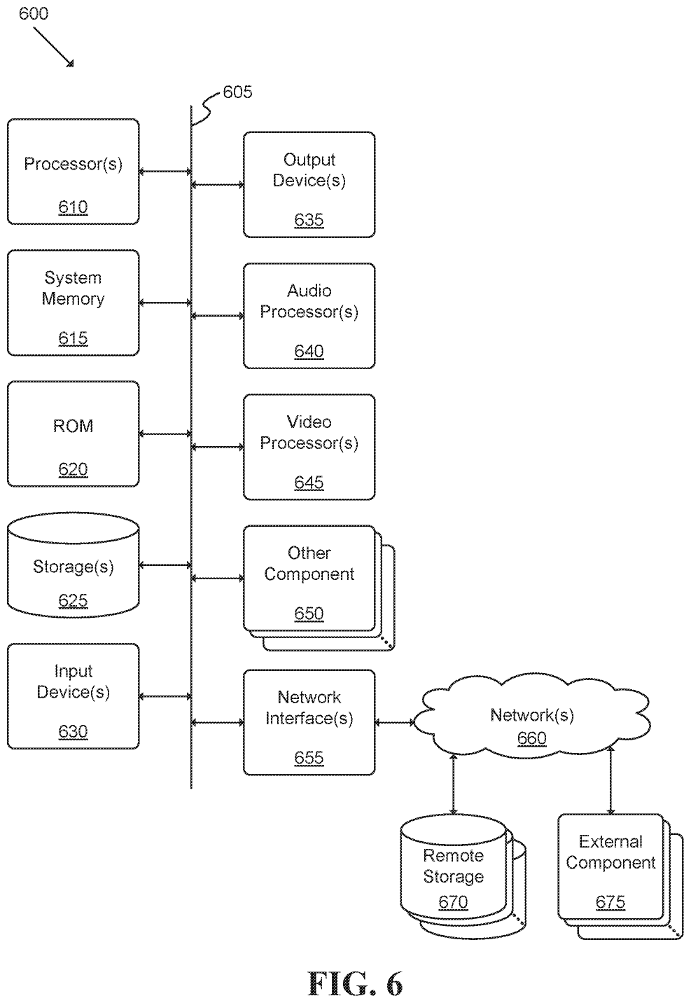

FIG. 6 illustrates a schematic block diagram of an exemplary computer system 600 used to implement some embodiments. For example, the system described above in reference to FIG. 1 may be at least partially implemented using computer system 600. As another example, the processes described in reference to FIGS. 3-5 may be at least partially implemented using sets of instructions that are executed using computer system 600.

Computer system 600 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 600 may include at least one communication bus 605, one or more processors 610, a system memory 615, a read-only memory (ROM) 620, permanent storage devices 625, input devices 630, output devices 635, audio processors 640, video processors 645, various other components 650, and one or more network interfaces 655.

Bus 605 represents all communication pathways among the elements of computer system 600. Such pathways may include wired, wireless, optical, and/or other appropriate communication pathways. For example, input devices 630 and/or output devices 635 may be coupled to the system 600 using a wireless connection protocol or system.

The processor 610 may, in order to execute the processes of some embodiments, retrieve instructions to execute and/or data to process from components such as system memory 615, ROM 620, and permanent storage device 625. Such instructions and data may be passed over bus 605.

System memory 615 may be a volatile read-and-write memory, such as a random access memory (RAM). The system memory may store some of the instructions and data that the processor uses at runtime. The sets of instructions and/or data used to implement some embodiments may be stored in the system memory 615, the permanent storage device 625, and/or the read-only memory 620. ROM 620 may store static data and instructions that may be used by processor 610 and/or other elements of the computer system.

Permanent storage device 625 may be a read-and-write memory device. The permanent storage device may be a non-volatile memory unit that stores instructions and data even when computer system 600 is off or unpowered. Computer system 600 may use a removable storage device and/or a remote storage device as the permanent storage device.

Input devices 630 may enable a user to communicate information to the computer system and/or manipulate various operations of the system. The input devices may include keyboards, cursor control devices, audio input devices and/or video input devices. Output devices 635 may include printers, displays, audio devices, etc. Some or all of the input and/or output devices may be wirelessly or optically connected to the computer system 600.

Audio processor 640 may process and/or generate audio data and/or instructions. The audio processor may be able to receive audio data from an input device 630 such as a microphone. The audio processor 640 may be able to provide audio data to output devices 640 such as a set of speakers. The audio data may include digital information and/or analog signals. The audio processor 640 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 645 (or graphics processing unit) may process and/or generate video data and/or instructions. The video processor may be able to receive video data from an input device 630 such as a camera. The video processor 645 may be able to provide video data to an output device 640 such as a display. The video data may include digital information and/or analog signals. The video processor 645 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 650 may perform various other functions including providing storage, interfacing with external systems or components, etc.

Finally, as shown in FIG. 6, computer system 600 may include one or more network interfaces 655 that are able to connect to one or more networks 660. For example, computer system 600 may be coupled to a web server on the Internet such that a web browser executing on computer system 600 may interact with the web server as a user interacts with an interface that operates in the web browser. Computer system 600 may be able to access one or more remote storages 670 and one or more external components 675 through the network interface 655 and network 660. The network interface(s) 655 may include one or more application programming interfaces (APIs) that may allow the computer system 600 to access remote systems and/or storages and also may allow remote systems and/or storages to access computer system 600 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

I claim:

1. A method that provides context-aware feedback options for a message, the method comprising:
analyzing (420) content associated with the message;
determining (430) a context of the message based on the content analysis; and
providing (470) a set of feedback options based on the context.

2. The method of claim 1, wherein determining a context comprises matching at least one content element of the message to an element included in a context profile.

3. The method of claim 2, wherein the context profile comprises the set of feedback options, and wherein the feedback options comprise at least one of text, an emoticon, audio feedback, and video feedback.

4. The method of claim 1, wherein analyzing content comprises at least one of image, metadata, and text analysis.

5. The method of claim 1 further comprising:
receiving a feedback selection from among the set of feedback options; and
updating the message based on the feedback selection.

6. A server that provides context-aware feedback to an message, the server comprising:
a processor for executing sets of instructions; and
a memory that stores the sets of instructions, wherein the sets of instructions comprise:
analyzing content associated with the message;
determining a context associated with the message based on the content analysis; and
providing a set of context-specific feedback options based on the context.

7. The server of claim 6, wherein determining a context comprises matching at least one content element of the message to an element included in a context profile.

8. The server of claim 7, wherein the context profile comprises the set of feedback options, and wherein the feedback options comprise at least one of text, an emoticon, audio feedback, and video feedback.

9. The server of claim 6, wherein analyzing content comprises at least one of image, metadata, and text analysis.

10. The server of claim 6, wherein the sets of instructions further comprise:
receiving a feedback selection from among the set of feedback options; and
updating the message based on the feedback selection.

11. A method for displaying feedback related to messages, the method comprising:
determining (520) a context of a message;
retrieving (530) information relating to the message and at least one feedback element associated with the message; and
modifying (570) at least one feedback element based on the retrieved information.

12. The method of claim 11, wherein determining a context comprises matching at least one content element of the message to an element included in a context profile.

13. The method of claim 12, wherein the context profile comprises a set of feedback element modifications.

14. The method of claim 11, further comprising:
analyzing retrieved feedback elements; and
providing an updated message with at least one modified feedback element.

15. A server that displays feedback related to messages, the server comprising:
a processor for executing sets of instructions; and
a memory that stores the sets of instructions, wherein the sets of instructions comprise:
determining a context of a message;
retrieving information relating to the message and at least one feedback element associated with the message; and
modifying at least one feedback element based on the retrieved information.

16. The server of claim 15, wherein determining a context comprises matching at least one content element of the message to an element included in a context profile.

17. The server of claim 16, wherein the context profile comprises a set of feedback element modifications.

18. The server of claim 15, wherein the sets of instructions further comprise:
analyzing retrieved feedback elements; and
providing an updated message with at least one modified feedback element.
